(19) United States
(12) Patent Application Publication
(10) Pub. No.: US 2019/0138966 A1
(43) Pub. Date: May 9, 2019

(54) CONTROL DEVICE, CONTROL METHOD AND STORAGE MEDIUM

(71) Applicant: FUJITSU LIMITED, Kawasaki-shi (JP)

(72) Inventor: Koji Morino, Fuji (JP)

(73) Assignee: FUJITSU LIMITED, Kawasaki-shi (JP)

(21) Appl. No.: 16/172,916

(22) Filed: Oct. 29, 2018

(30) Foreign Application Priority Data
Nov. 7, 2017 (JP) 2017-214793

(51) Int. Cl. G06Q 10/06; G06F 17/30; G06Q 30/00

(52) U.S. Cl. CPC G06Q 10/06316; G06F 17/30551; G06Q 30/016; G06F 17/3053

(57) ABSTRACT

A non-transitory computer-readable storage medium storing a program that causes a computer to execute a process, the process includes receiving an input of load information of work for handling an inquiry or an incident in association with each of a plurality of pieces of reference information, and controlling a degree of priority of reference information to be output according to retrieval relating to the inquiry with respect to each of the plurality of reference information in accordance with the load information input relating to the reference information.

### CROSS-REFERENCE TO RELATED APPLICATION

This application is based upon and claims the benefit of priority of the prior Japanese Patent Application No. 2017-214793, filed on Nov. 7, 2017, the entire contents of which are incorporated herein by reference.

### FIELD

The embodiments discussed herein are related to a control device, a control method, and a storage medium.

### BACKGROUND

Due to the diversification of the Internet usage environment (PC, tablet, smartphone, and so forth), and rapid spread of a cloud computing, inquiries to the support department relating to products, goods, and so forth are increasing not only from the system division of the company which has installed the products and so forth but also from end users of the system division which actually use the product and so forth.

In response to increasing inquiries, and with the aim of an early settlement of inquiries and reduction in man-hours in the support department, the inquiries that the support department has handled in the past have been made public as examples of frequently asked questions.

A conventional method of giving priority to effective cases among many cases is generally to perform an evaluation by the degree of the cumulative reference frequency of the cases in the past.

Methods have been offered in which without simply using the cumulative reference frequency from the past, the priority order is determined by multiplying the reference frequency per month by a coefficient (the coefficient for the latest reference frequency is made to be large), thereby giving priority to even a new case with low reference frequency (cumulative frequency) (see, for example, Japanese Laid-open Patent Publication No. 2003-186977, and Japanese Laid-open Patent Publication No. 2015-64643, and so forth).

However, the case which is highly rated based on the cumulative reference frequency is not necessarily a case which is effective for the user to solve the inquiry. For example, it is considered that a case where more efficient handling of a problem to be inquired is available (for example, fewer man-hours) is a case which is effective for the user. In view of the above, it is desirable to be able to support the efficiency of work on inquiries.

### SUMMARY

According to an aspect of the embodiments, a non-transitory computer-readable storage medium storing a program that causes a computer to execute a process, the process includes receiving an input of load information of work for handling an inquiry or an incident in association with each of a plurality of pieces of reference information, and controlling a degree of priority of reference information to be output according to retrieval relating to the inquiry with respect to each of the plurality of reference information in accordance with the load information input relating to the reference information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of a case providing system according to an embodiment discussed herein;

FIG. 2 is a diagram illustrating an example of a hardware configuration of a case providing device 10 according to an embodiment discussed herein;

FIG. 3 is a diagram illustrating an example of a functional configuration of the case providing device 10 according to an embodiment discussed herein;

FIG. 4 is a flowchart for explaining an example of a process procedure of a process of registering case information;

FIGS. 5A and 5B are diagrams illustrating an example of a configuration of a case DB 141;

FIG. 6 is a flowchart for explaining an example of a process procedure of a process of providing case information corresponding to a query;

FIG. 7 is a diagram illustrating an example of a configuration of a reference history DB 142;

FIGS. 8A, 8B and 8C are diagrams illustrating an example of a reference history of respective target case information;

FIG. 9 is a flowchart for explaining an example of a process procedure of a process of calculating a prediction value of the reference frequency;

FIG. 10 is a diagram illustrating an example of a counting result of the reference frequency of respective target case information for unit period;

FIG. 11 is a diagram illustrating examples of approximate straight line equations with respect to respective target case information;

FIG. 12 is a diagram illustrating an example of a calculation result of a prediction value of the reference frequency;

FIG. 13 is a diagram illustrating the relationship between respective unit periods and the reference frequency with a line graph;

FIG. 14 is a flowchart for explaining an example of a process procedure of a process of calculating a handling difficulty level;

FIG. 15 is a diagram illustrating an example of the calculation result of the handling difficulty level;

FIG. 16 is a diagram illustrating an example of a calculation result of a degree of priority;

FIG. 17 is a diagram illustrating an example of a date of each reference history;

FIG. 18 is a diagram illustrating a counting result of the reference frequency on a monthly basis;

FIG. 19 is a diagram illustrating the counting result of the reference frequency on a monthly basis by a bar chart;

FIG. 20 is a diagram illustrating a counting result of the reference frequency on a two-monthly basis; and

FIG. 21 is a diagram illustrating the counting result of the reference frequency on a two-monthly basis by a bar chart.

### DESCRIPTION OF EMBODIMENTS

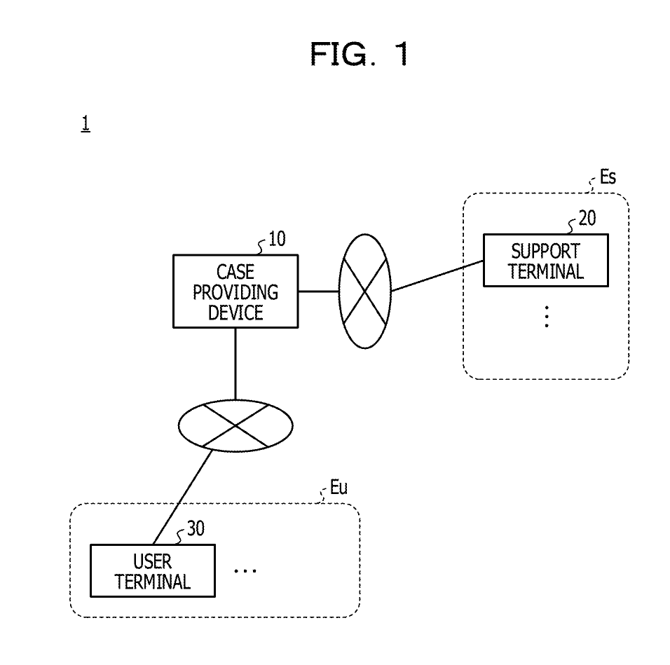

Embodiments discussed herein will be described below with reference to the drawings. FIG. 1 is a diagram illustrating an example of a configuration of a case providing system according to an embodiment discussed herein. In FIG. 1, a case providing system 1 includes a case providing device 10, one or more support terminals 20, one or more user terminals 30, and so forth. The case providing device 10 and each support terminal 20 are connected to each other via a network such as a LAN (Local Area Network) or the Internet. The case providing device 10 and each user terminal 30 are connected to each other via a network such as the Internet.

The support terminal 20 is a terminal used by a person belonging to a support environment Es. The support environment Es is, for example, a department that handles an incident by telephone or mail from the end user at a company or the like who manufactures or sell a certain product, goods, or the like (hereinafter referred to as product A for convenience). Therefore, the person who belongs to the support environment Es is referred to as a person in charge of handling the incident (hereinafter referred to as “support person”). The support terminal 20 is used for inputting information (hereinafter referred to as “case information”) indicating the contents of correspondence relating to the incident handled by the support person. The support terminal 20 transmits the request for the registration of the input case information to the case providing device 10. For example, a PC, a smartphone, a tablet terminal, or the like may be used as the support terminal 20.

In the present embodiment, the incident means an inquiry relating to the product A from the user. In the present embodiment, the inquiry includes not only an inquiry when problems such as faults and troubles occur to the product A but also user's question in which the user simply does not know how to use the product A, for example.

The user terminal 30 is a terminal used by a person belonging to a user environment Eu. The user environment Eu is an environment to which the end user of the product A belongs. The user terminal 30 is used for inputting an inquiry (incident) on the product A. The user terminal 30 transmits the input inquiry to the case providing device 10, and displays case information provided (returned) from the case providing device 10 in response to the inquiry. For example, a PC, a smartphone, a tablet terminal, or the like may be used as the user terminal 30.

The case providing device 10 is one or more computers that manage case information of the product A. The case providing device 10 stores case information relating to the request for the registration from the support terminal 20. The case providing device 10 provides (returns) the case information corresponding to the inquiry transmitted from the user terminal 30 to the user terminal 30.

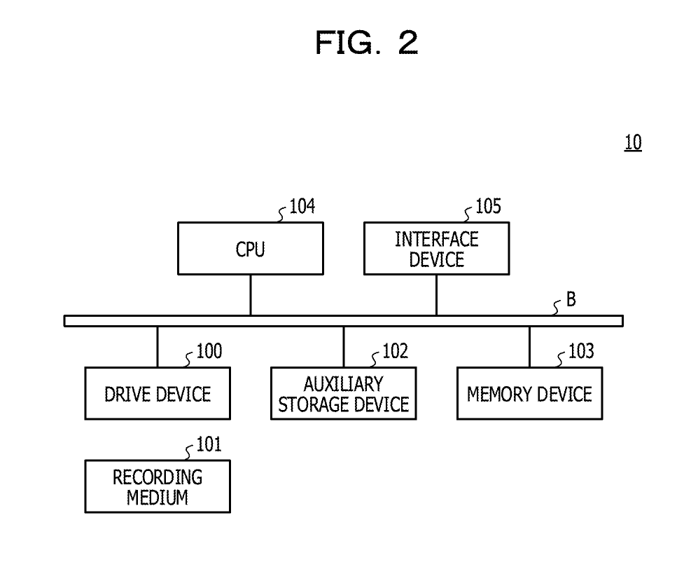

FIG. 2 is a diagram illustrating an example of a hardware configuration of the case providing device 10 according to an embodiment discussed herein. The case providing device 10 of FIG. 2 includes a drive device 100 an auxiliary storage device 102, a memory device 103, a CPU 104, and an interface device 105, and so forth, all of which are mutually connected via a bus B.

The program that executing the processing in the case providing device 10 is provided by a recording medium 101 such as an optical disk. After the recording medium 101 storing the program is set in the drive device 100, the program is installed from the recording medium 101 to the auxiliary storage device 102 via the drive device 100. However, the program is not necessarily installed from the recording medium 101. The program may be downloaded from another computer via a network. The auxiliary storage device 102 stores the installed program, and stores proper files, data, and so forth.

The memory device 103 reads the program from the auxiliary storage device 102 and stores the program when an instruction to activate the program is made. The CPU 104 executes functions relating to the case providing device 10 according to the program stored in the memory device 103. The interface device 105 is used as an interface for connecting the case providing device 10 to the network.

The recording medium 101 is for example, a CD-ROM, a DVD disk, or a portable recording medium such as a USB memory. The auxiliary storage device 102 is for example, an HDD (Hard Disk Drive), a flash memory or the like. The recording medium 101 and the auxiliary storage device 102 correspond to a computer-readable recording medium.

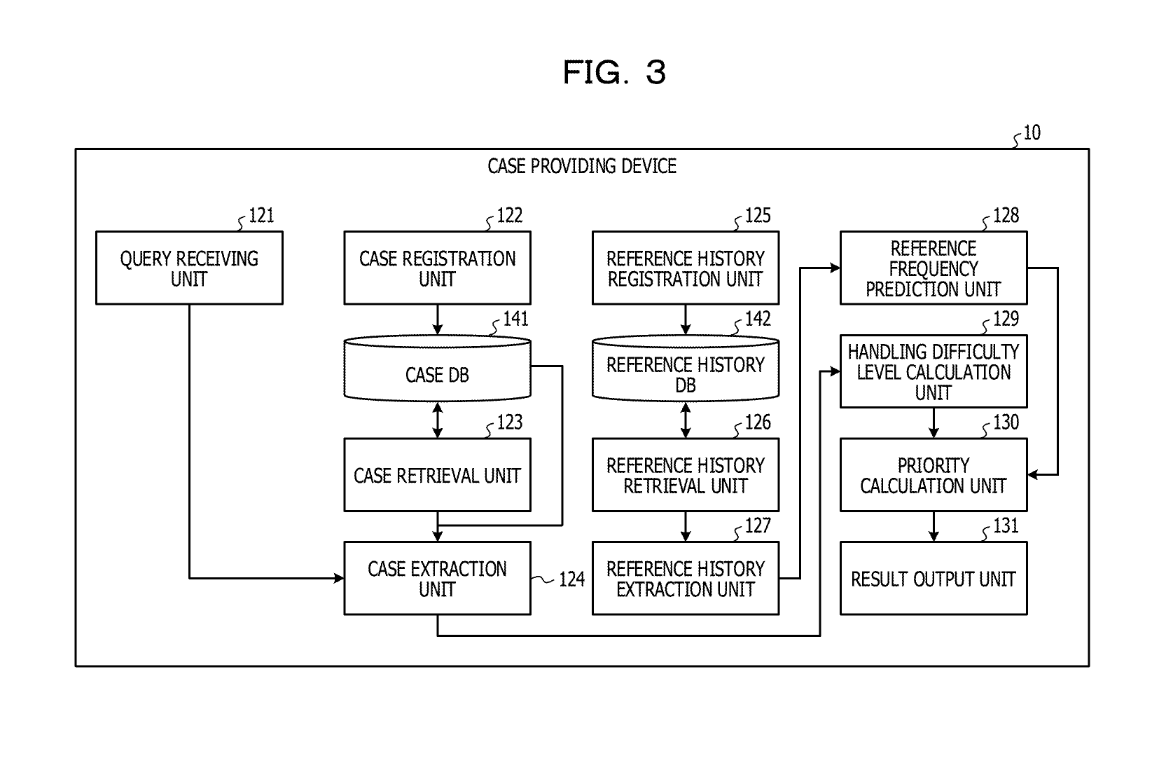

FIG. 3 is a diagram illustrating an example of a functional configuration of the case providing device 10 according to an embodiment discussed herein. In FIG. 3, the case providing device 10 includes a query receiving unit 121, a case registration unit 122, a case retrieval unit 123, a case extraction unit 124, a reference history registration unit 125, a reference history retrieval unit 126, a reference history extraction unit 127, a reference frequency prediction unit 128, a handling difficulty level calculation unit 129, a priority calculation unit 130, a result output unit 131, and so forth. These components are implemented by processes that one or more programs installed in the case providing device 10 causes the CPU 104 to execute. The case providing device 10 uses a database such as a case DB 141 and a reference history DB 142. Each of these databases may be established by, for example, the auxiliary storage device 102, or a storage device or the like connectable to the case providing device 10 via a network.

The query receiving unit 121 receives the query input by the user at the user terminal 30. The query is a character string indicating the content of the inquiry by the user.

The case registration unit 122 accepts input of case information indicating the contents of correspondence to an inquiry from the user of the product A in the support department of the product A, and registers the case information in the case DB 141. The case retrieval unit 123 performs retrieval of the query received by the query receiving unit 121 as a retrieval condition on the case DB 141. The case extraction unit 124 extracts from the case DB 141 case information that has matched with the retrieval result by the case retrieval unit 123.

When any one of the case information extracted by the case extraction unit 124 is referred to by the user (hereinafter referred to as target case information), the reference history registration unit 125 registers in the reference history DB 142 the reference history relating to the case information which has been referred. The reference history retrieval unit 126 retrieves the reference history stored in the reference history DB 142 for respective target case information. The reference history extraction unit 127 extracts each reference history retrieved by the reference history retrieval unit 126 from the reference history DB 142.

The reference frequency prediction unit 128 predicts the reference frequency in the future of respective target case information based on the reference history of respective target case information. For example, the reference frequency prediction unit 128 totals, among the reference histories of respective target case information, the reference frequency of respective target case information for unit period (for example, one month) based on the reference history registered during a predetermined evaluation period (for example, the most recent half year). The reference frequency prediction unit 128 calculates an approximate straight line of a linear function (y=ax+b) for respective target case information where the unit period is the x coordinate, and the reference frequency is the y coordinate. The gradient “a” and the intercept “b” of the approximate straight line are obtained by, for example, the least squares method. Based on the calculated approximate straight line, the reference frequency prediction unit 128 calculates a prediction value of the reference frequency in the future, for example, the reference frequency in the next unit period, with respect to respective target case information.

The handling difficulty level calculation unit 129 calculates the degree of difficulty of handling the case (hereinafter referred to as handling difficulty level) based on information indicating the load (workload and so forth) relating to the handling of the inquiries wherein the load information is included in respective target case information. In this embodiment, the handling difficulty level may also be an index indicating the efficiency in handling the inquiry. The handling difficulty level has a large value for a case in which it is easy to handle the inquiry.

The priority calculation unit 130 controls the degree of priority with respect to respective target case information based on at least one of the prediction value calculated by the reference frequency prediction unit 128 and the handling difficulty level calculated by the handling difficulty level calculation unit 129.

The result output unit 131 transmits to the user terminal 30 the result of rearranging (sorting) respective target case information according to the degree of priority controlled by the priority calculation unit 130.

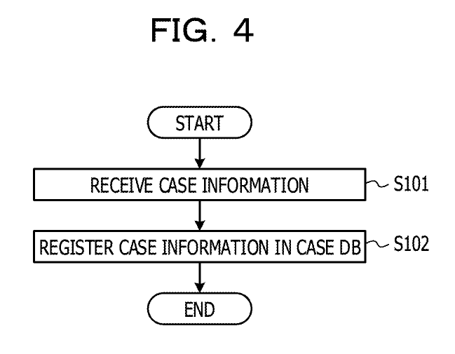

The process procedure performed by the case providing device 10 will be described below. FIG. 4 is a flowchart for explaining an example of a process procedure of a process of registering case information.

An inquiry about the product A is received from a user by phone or the like, and the support person who handled the inquiry inputs case information of the handling to the support terminal 20. The support terminal 20 transmits the input case information to the case providing device 10.

In S101, the case registration unit 122 receives the case information. Subsequently, the case registration unit 122 registers the case information in the case DB 141 (S102).

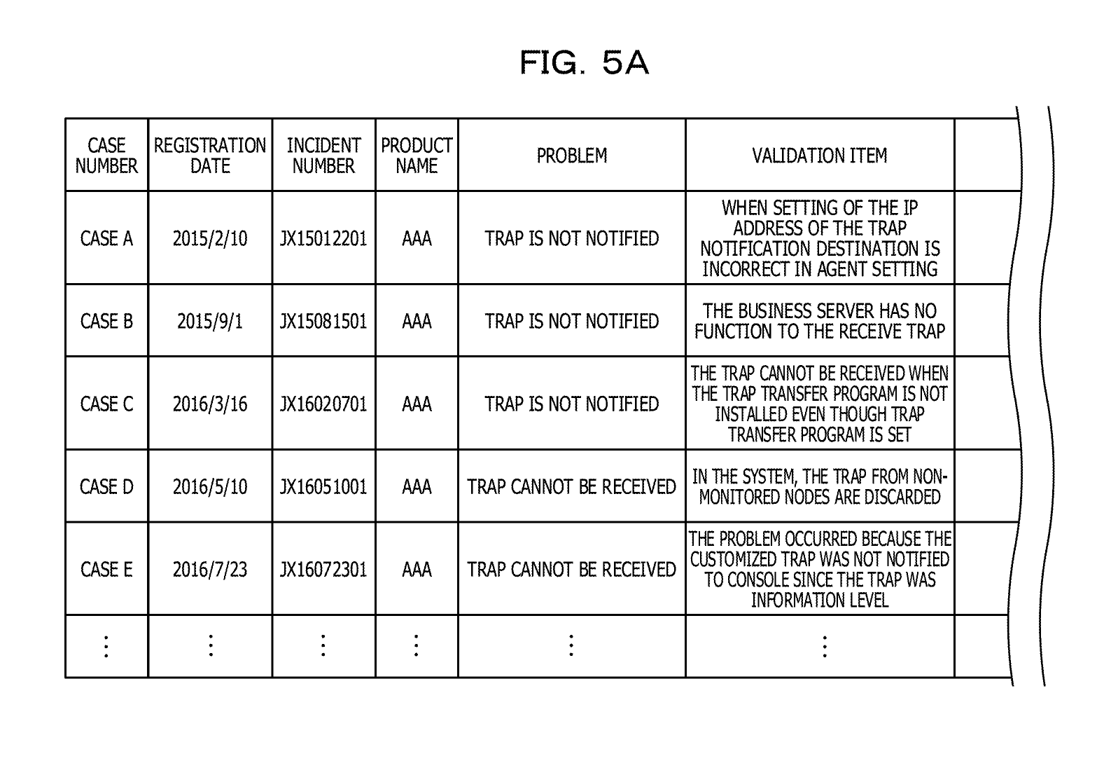

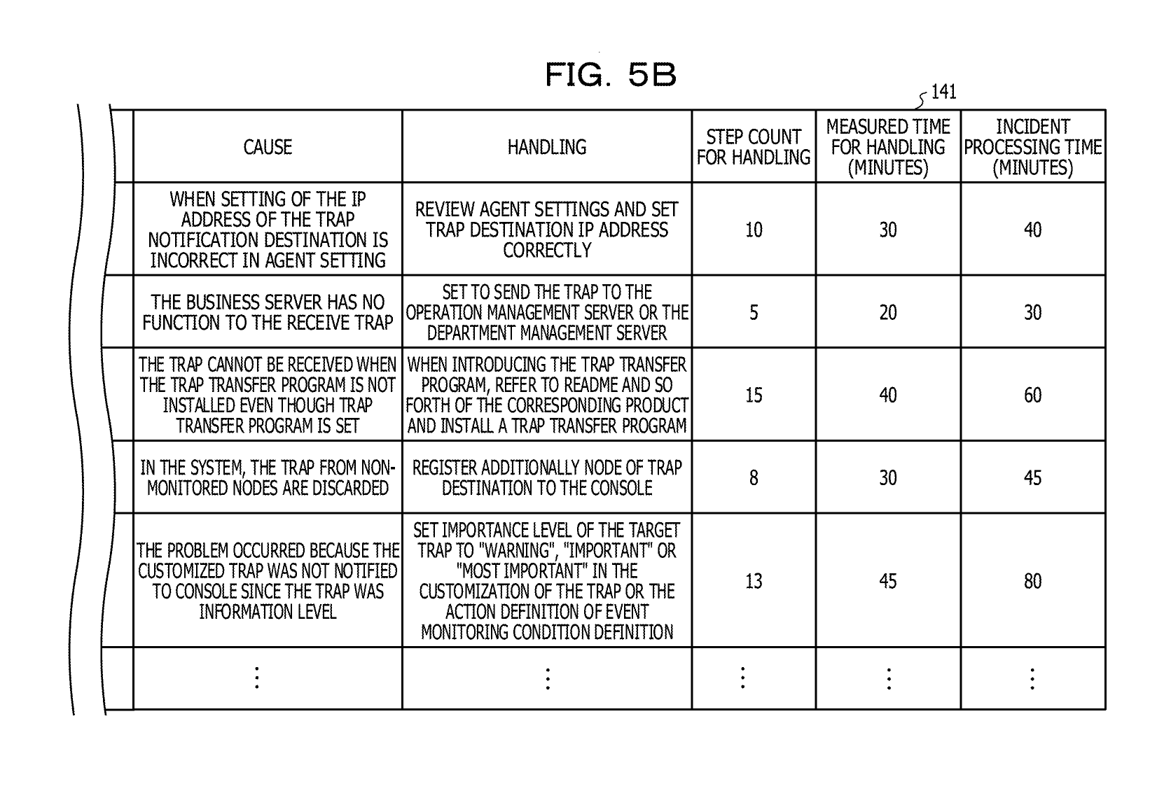

FIGS. 5A and 5B are diagrams illustrating a configuration example of the case DB 141. As illustrated in FIGS. 5A and 5B, respective records of the case DB 141 stores case information including a case number, a registration date, an incident number, a product name, a problem, a validation item, a cause, handling, a step count for handling, a measured time for handling, an incident processing time, and so forth.

The case number is a piece of identification information of each cases. The registration date is a registration date of the case information. The incident number is a piece of identification information of an incident (inquiry). The product name is a name of the product A to be inquired. The problem is a piece of information indicating a problem described in the inquiry. The validation item is a piece of information indicating items to be validated in order to investigate the cause, and so forth of the problem when the problem occurs. The cause is a cause of the problem. The handling is a work done to remove the cause (to resolve the inquiry). The step count for handling is a piece of information indicating the number of steps (for example, a degree of complication) of the work relating to the handling. For example, the number of commands (number of operations) input to the console for this work may be the step count for handling. The measured time for handling is a time measured for direct work relating to the handling. The step count for handling and the measured time for handling are the step count and the measured time relating to the work by the user when the work relating to the handling occurs on the user side. The incident processing time is an elapsed time (measured time) from the time the support person accepts the inquiries until the inquiry is resolved.

The case number and the registration date may not be input by the support person. For example, the case registration unit 122 may automatically assign the case number and the registration date to the case information.

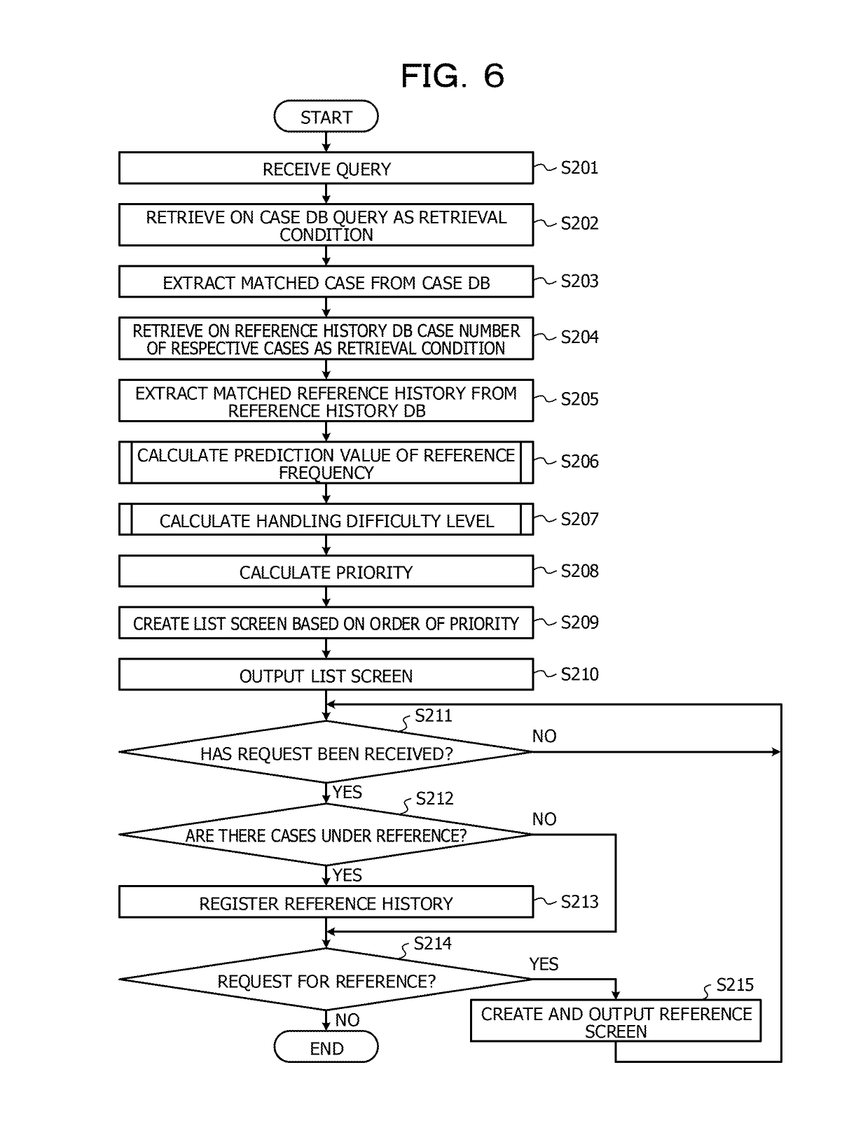

FIG. 6 is a flowchart for explaining an example of a process procedure of a process of providing case information corresponding to a query.

In S201, the query receiving unit 121 receives the query which is input to the user terminal 30, and sent from the user terminal 30. For example, a query of “Trap is not notified.” may be received.

Subsequently, the case retrieval unit 123 performs on the case DB 141 retrieval with respect to the query as a retrieval condition (S202). For example, the case retrieval unit 123 retrieves case information in which the value of the problem matches with the retrieval condition (query). For example, when the retrieval condition (query) is “Trap is not notified.”, case information in which the value of the problem matches with “Trap is not notified.” is retrieved. However, the retrieval method may not be limited to the exact match of the character string, and a more ambiguous retrieval may be performed using a known retrieval technique.

Next, the case extraction unit 124 extracts from the case DB 141 case information that has matched with the retrieval result by the case retrieval unit 123 (S203). When the retrieval condition is “Trap is not notified.”, three pieces of case information in which the case number is the case A, the case B, the case C are extracted based on the example of FIGS. 5A and 5B. The extracted case information is hereinafter referred to as target case information.

Subsequently, the reference history retrieval unit 126 performs retrieval on the reference history DB 142 (S204) with respect to the case number of respective target case information as a retrieval condition.

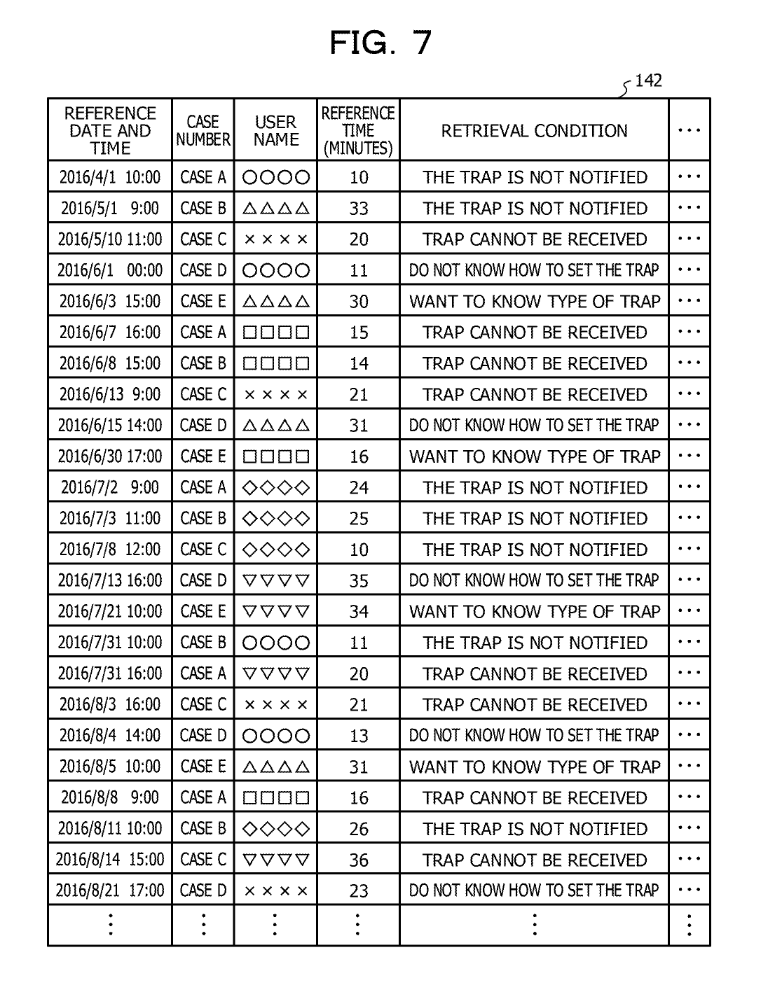

FIG. 7 is a diagram illustrating an example of a configuration of the reference history DB 142. As illustrated in FIG. 7, each record of the reference history DB 142 stores the reference history including a reference date and time, a case number, a user name, a reference time, a retrieval condition, and so forth.

The reference date and time is a date and time when reference was made with respect to the case information associated with the case number. The case number is a case number of the case information to be referred. The user name is a piece of identification information of the user who made the reference. The reference time is a time period for which the reference was made (measured time for the reference). The retrieval condition is a retrieval condition (query) input when the case information to be referred was referred.

Subsequently, the reference history extraction unit 127 extracts the reference history of respective target case information that has matched with the retrieval result by the reference history retrieval unit 126 from the reference history DB 142 in chronological order (S205).

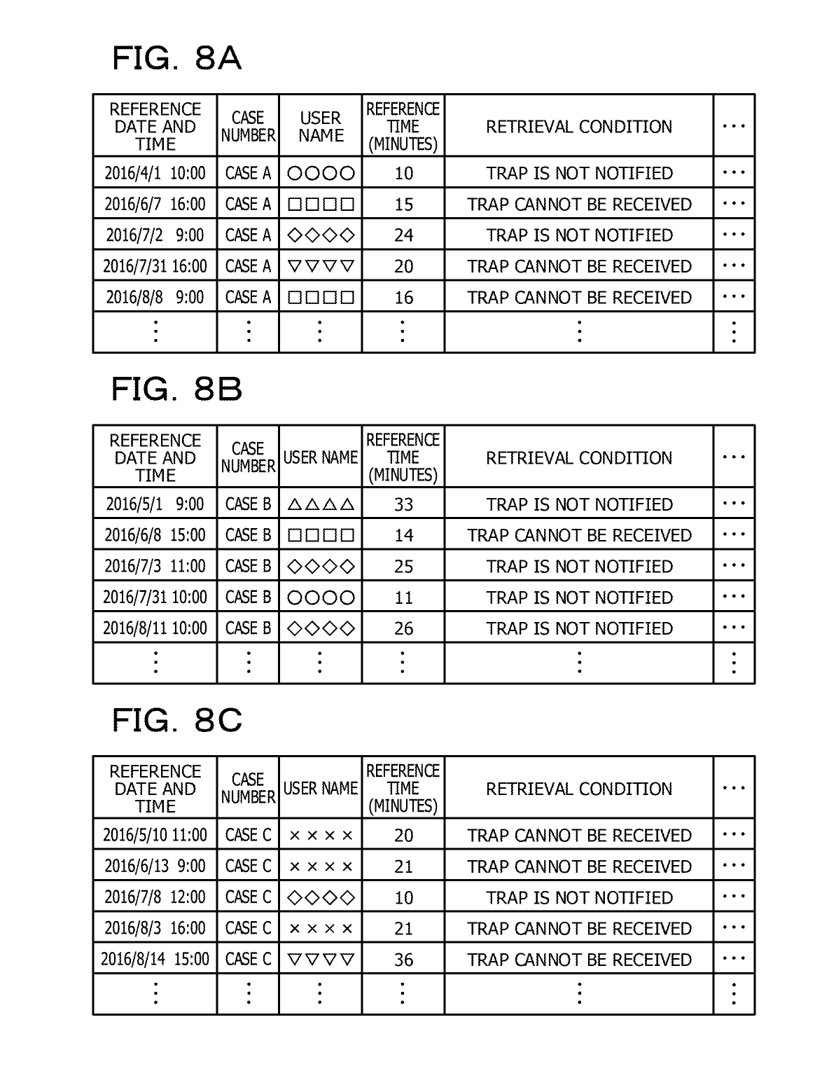

FIGS. 8A to 8C are diagrams illustrating an example of the reference histories of respective target case information. FIG. 8A illustrates a set of reference histories of the case A. FIG. 8B illustrates a set of reference histories of the case A. FIG. 8C illustrates a set of reference histories of the case C.

Subsequently, the reference frequency prediction unit 128 performs calculation processing of a prediction value of the reference frequency with respect to respective target case information (S206). By performing calculation processing of the prediction value of the reference frequency, the prediction value of the reference frequency in the future is calculated with respect to respective target case information.

Subsequently, the handling difficulty level calculation unit 129 performs calculation processing of the handling difficulty level with respect to respective target case information (S207). The handling difficulty level with respect to respective target case information is calculated by performing calculation processing of the handling difficulty level.

Subsequently, the priority calculation unit 130 controls the degree of priority of respective target case information based on the prediction value of the reference frequency of respective target case information and the handling difficulty level of respective target case information (S208).

Subsequently, the result output unit 131 creates a screen (hereinafter referred to as list screen) on which case numbers of respective target case information are arranged as selection options in order based on the degree of priority of respective target case information (S209). For example, the list screen may be a screen including a list in which the case numbers of respective target case information is sorted in descending order according to the degree of priority. Subsequently, the result output unit 131 transmits (outputs) the list screen to the user terminal 30, which is the sender of the query (S210).

Upon receiving the list screen, the user terminal 30 displays the list screen. At this time, the case numbers of respective target case information are displayed in order according to the degree of priority. As a result, target subject case information having high degree of priority in the list of the target case information is displayed in a state where it is easy for the user to refer to the target case information. When the user selects any one of the case numbers on the list screen, the user terminal 30 transmits to the case providing device 10 the request for the reference including the request for the case number. On the other hand, when the user selects the end button on the list screen, the user terminal 30 closes the list screen and transmits the request for the end to the case providing device 10.

When the result output unit 131 receives the request for the reference or the request for the end (“Yes” in S211), the reference history registration unit 125 determines presence or absence of target case information which is being referred on a reference screen to be described later (for example, whether the case number of any one of the target reference case information is already selected on the list screen) (S212).

When target case information which is being referred is present (“Yes” in S212), the reference history registration unit 125 registers the reference history for the target case information in the reference history DB 142 and the process proceeds to S214 (S213). At this time, the current date and time or the date and time when the reference screen of the target history information was transmitted to the user terminal 30 is registered as the registration date and time of the registered reference history. The case number of the target case information which was being referred is registered as the case number of the reference history. The user name of the user who inputs the query is registered as the user name of the reference history. Before the input of the query, the case providing device 10 may authenticate the user, and the user name may be specified by the authentication. As the reference time of the reference history, for example, the elapsed time from the transmission of the reference screen of the target case information to the current time is registered. The query received in S201 is registered as the retrieval condition of the reference history.

On the other hand, when the list screen is transmitted to the user terminal 30 and the first request for the reference is received, or when the request for the end is received without receiving the request for the reference at all, no target case information which is being referred is present. In this case (“No” in S212), S213 is not performed and the process proceeds to S214.

Subsequently, when the request received in S210 is the request for the reference (“Yes” in S214), the result output unit 131 generates a reference screen for causing to refer to the content of the target case information associated with the case number included in the request for the reference (S215). On the reference screen, for example, the validation item, the cause, the handling, and so forth of the target case information are included as items to be displayed. However, values of other items of the target case information may be items to be displayed on the reference screen.

Subsequently, the result output unit 131 transmits (outputs) the generated reference screen to the user terminal 30, which is the sender of the request for the reference (S215), and the process returns to S211.

On the other hand, when the request received in S210 is the request for the end (“Yes” in S214), the process procedure of FIG. 6 ends.

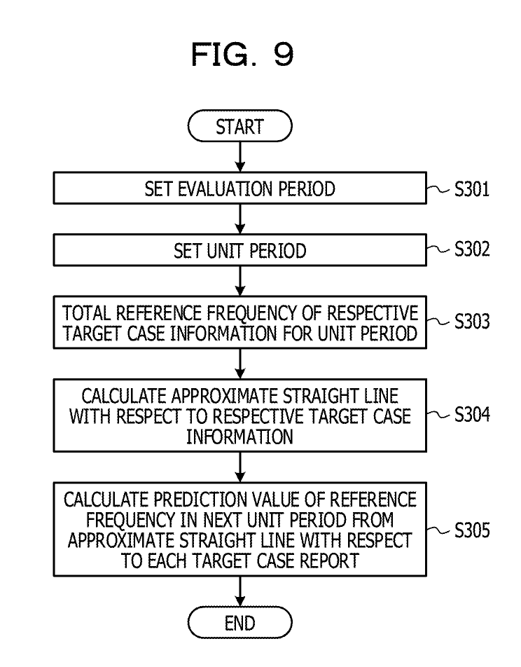

Next, the details of S206 will be described. FIG. 9 is a flowchart for explaining an example of a process procedure of a process of calculating a prediction value of the reference frequency.

In step S301, the reference frequency prediction unit 128 sets an evaluation period. The evaluation period is a temporal range of the reference history used for calculating the prediction value of the reference frequency. The evaluation period may be set in advance, or may be dynamically determined based on the reference history of respective target case information by a method described later. When set in advance, the elapsed period from the start of sales of the product A to the present time may be set as the evaluation period, or part of the elapsed period may be set as the evaluation period.

Subsequently, the reference frequency prediction unit 128 sets a unit period (S302). The unit period is a period obtained by dividing the evaluation period into a plurality of periods, wherein the reference frequency of respective target case information is totaled during the period. The unit period may also be set in advance, or may be dynamically determined based on the reference history of respective target case information by a method described later. When set in advance, the unit period may be set based on the characteristics of the product A.

Subsequently, the reference frequency prediction unit 128 totals the reference frequency of respective target case information for unit period (S303). For example, the number of reference histories in which the reference date and time is included in the unit period is counted for unit period with respect to respective target case information. For example, in the case A, the number of reference histories illustrated in FIG. 8A is counted for unit period.

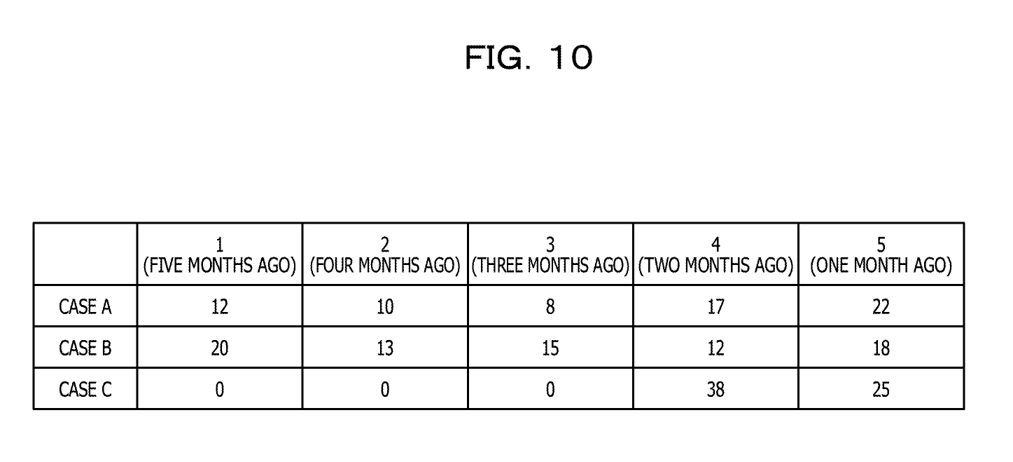

FIG. 10 is a diagram illustrating an example of the counting result of the reference frequency of respective target case information for unit period. FIG. 10 illustrates the counting results of the reference histories of the case A to the case C for each of the unit periods of “1” to “5”. Hereinafter, any number from “1” to “5” assigned to each unit period is referred to as unit period number. In FIG. 10, an example in which the evaluation period is 5 months, and the unit period is one month is illustrated. For example, the unit period 5 illustrates the counting result of the reference frequency for the most recent one month.

Subsequently, the reference frequency prediction unit 128 calculates an approximate straight line indicating the relationship between the unit period and the reference frequency in the coordinate system with the unit period as the x axis, and the reference frequency as the y axis for each target case information (S304). The approximate straight line has the form of a linear equation (y=ax+b). For example, the approximate straight line may be calculated by the least squares method based on the record illustrated in FIG. 10. In this case, the slope “a” and the y intercept “b” may be calculated as follows.

$$a = \frac{n {\sum }_{i = 1}^{n} XiYi - {\sum }_{i = 1}^{n} Xi {\sum }_{i = 1}^{n} Yi}{n {\sum }_{i = 1}^{n} {( Xi )}^{2} - {( {\sum }_{i = 1}^{n} Xi )}^{2}} \\ b = \frac{{\sum }_{i = 1}^{n} {( Xi )}^{2} {\sum }_{i = 1}^{n} Yi - {\sum }_{i = 1}^{n} XiYi {\sum }_{i = 1}^{n} Xi}{n {\sum }_{i = 1}^{n} {( Xi )}^{2} - {( {\sum }_{i = 1}^{n} Xi )}^{2}} \qquad [ Math . 1 ]$$

where xi represents the unit period number of the i-th unit period, and yi represents the reference frequency of the i-th unit period.

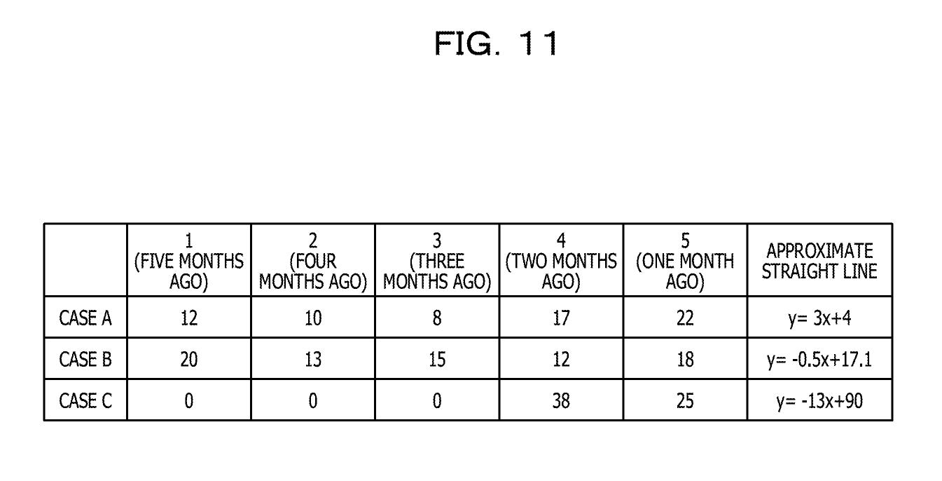

FIG. 11 is a diagram illustrating examples of approximate straight line equations with respect to respective target case information. FIG. 11 illustrates examples of the approximate straight line equations wherein the approximate straight line equation of the case A is represented by y=3x+4, the approximate straight line equation of the case A is represented by y=−0.5x+17.1 and the approximate straight line equation of the case A is represented by y=−13x+90.

Subsequently, the reference frequency prediction unit 128 calculates a prediction value of the reference frequency in the next unit period based on respective approximate straight lines with respect to respective target case information (S305). In this case, when it is assumed that the unit period number of the last unit period out of the unit periods to be counted is N, N+1 is assigned in “x” of the approximate straight line. For example, according to the example of FIG. 11, N=5. Therefore, “6” is assigned in “x”. The value of “y” calculated as a result is the prediction value of the reference frequency in the next unit period.

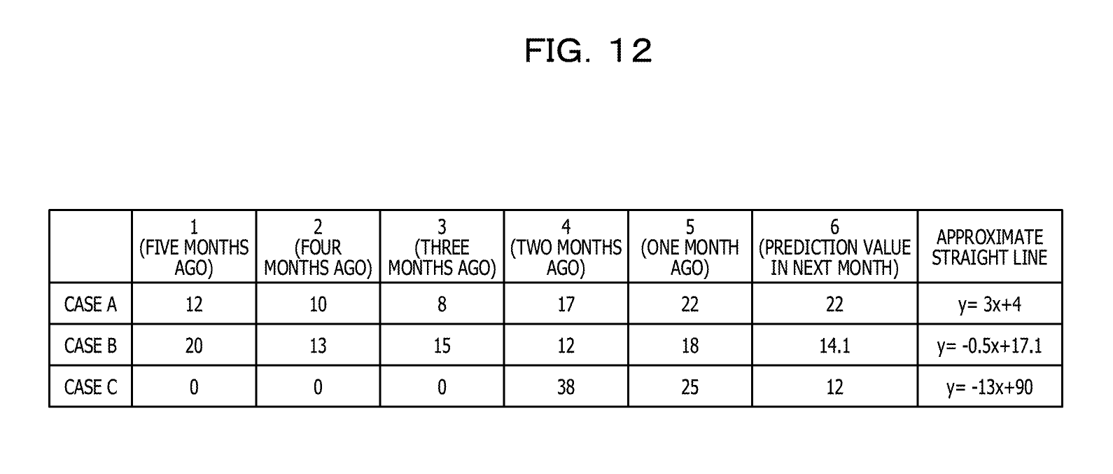

FIG. 12 is a diagram illustrating an example of the calculation result of the prediction value of the reference frequency. In FIG. 12, values of a column with the unit period number of “6” (a column of prediction value of the next month) indicate prediction values of the reference frequency. According to the example of FIG. 12, the prediction values are 22, 14.1, and 12 in the case A, the case B, and the case C respectively.

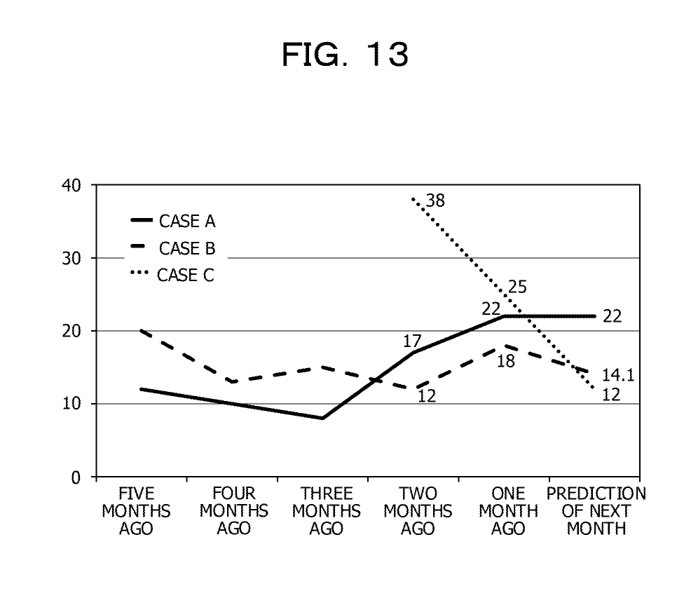

FIG. 13 is a diagram illustrating the relationship between respective unit periods and the reference frequency with a line graph. FIG. 13 illustrates a line graph indicating the relationship between the reference frequency of the unit period included in the evaluation period and the prediction value of the reference frequency of the next unit period for respective target case information. Therefore, the line graph illustrated in FIG. 13 is not approximate straight lines.

Calculating the future (the next unit period) prediction value based on the approximate straight line in the evaluation period makes it possible to obtain a prediction value in which the reference frequency in the evaluation period has been taken into consideration. As a result, it is possible to predict the fluctuation tendency of the reference frequency in the future. For example, according to FIG. 13, it may be said that the reference frequency of the case A has a tendency to increase, the reference frequency of the case B has a tendency not to change, and the reference frequency of the case C has a tendency to decrease.

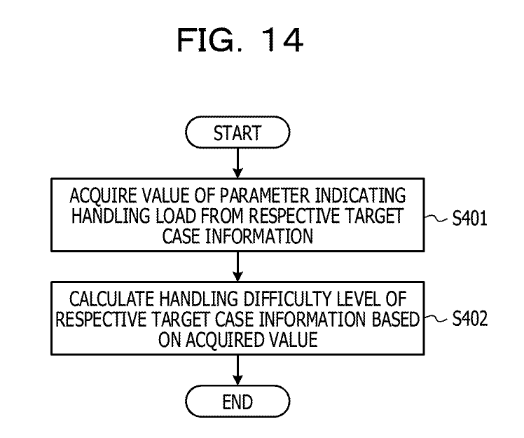

Next, the details of S207 in FIG. 6 will be described. FIG. 14 is a flowchart for explaining an example of the process procedure of a process of calculating a handling difficulty level.

In step S401, the handling difficulty level calculation unit 129 acquires a value of a parameter (item) indicating a handling load from respective target case information. In the present embodiment, the parameter includes the step count for handling, the measured time for handling and the incident processing time.

Subsequently, the handling difficulty level calculation unit 129 calculates the handling difficulty level based on the acquired value for respective target case information (S402). The handling difficulty level of one piece of target case information is calculated, for example, by the following expression. The handling difficulty level=1×{(1/step count for handling) or (1/measured time for handling) or (1/incident processing time)}×100

This equation indicates that the handling difficulty level is one of the reciprocal of the step count for handling, the reciprocal of the measured time for handling, and the reciprocal of the incident processing time. However, for example, the reciprocal of the sum of the values of any two or more parameters may be set as the handling difficulty level. In either case of using one parameter or of using two or more parameters, it is desirable that the parameters used for calculating the handling difficulty level be common to respective target case information. As long as it is possible to evaluate the magnitude of the workload for the handling, the handling difficulty level may be calculated by another arithmetic equation.

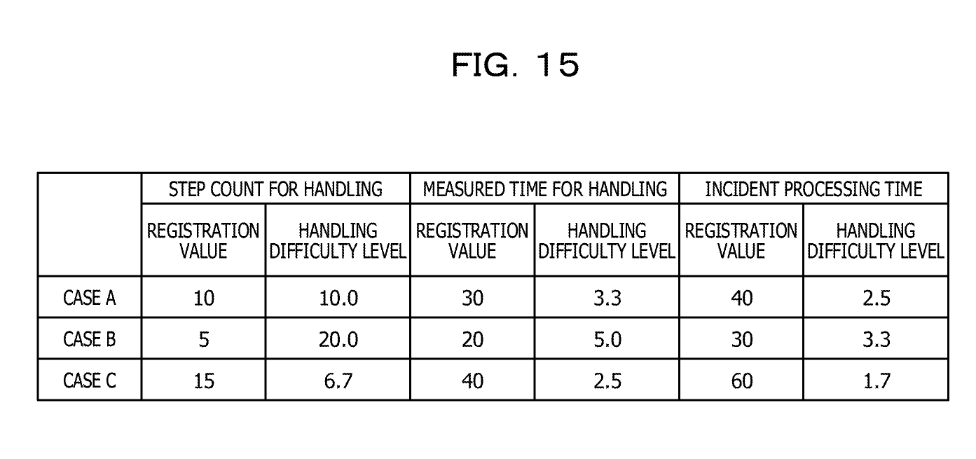

FIG. 15 is a diagram illustrating an example of the calculation result of the handling difficulty level. FIG. 15 illustrates the registered value and the handling difficulty level based on the registered value for each of the step count for handling, the measured time for handling and the incident processing time as a parameter for respective cases A, case B and the case C. The registered value is a value registered in the case DB 141 illustrated in FIGS. 5A and 5B. In FIG. 15, the handling difficulty levels with respect to all three parameters are illustrated. According to the above equation, the handling difficulty level with respect to any one parameter may be calculated.

Next, details of S208 of FIG. 6 will be described. The priority calculation unit 130 calculates the degree of priority, for example, based on the following equation for respective target case information. Degree of priority=Prediction value of reference frequency×Handling difficulty level

For example, the degree of priority is calculated by multiplying the prediction value of the reference frequency of the next unit period calculated by the number of reference frequency prediction unit 128 by the handling difficulty level calculated by the handling difficulty level calculation unit 129 as a weight with respect to a piece of target case information.

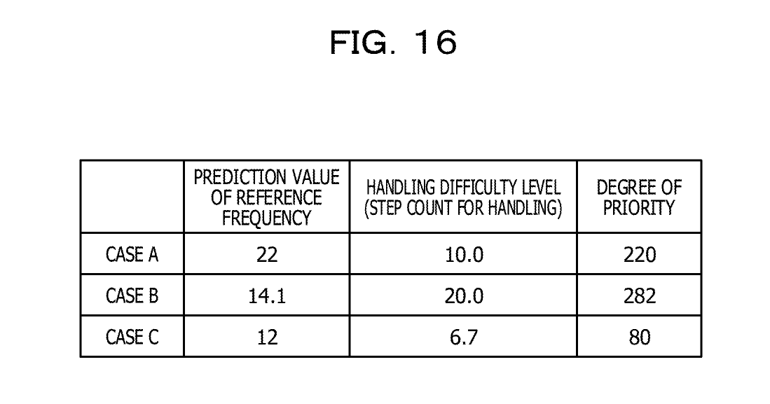

FIG. 16 is a diagram illustrating an example of the calculation result of the degree of priority. FIG. 16 illustrates the calculation results of the priorities of the case A, the case B, and the case C when the handling difficulty level based on the step count for handling is used.

In this case, in S209 of FIG. 6, the result output unit 131 transmits to the user terminal 30 a list screen including the case numbers of respective case information in the order of the case B, the case A, and the case C.

However, without using the prediction value of the reference frequency, the handling difficulty level may be regarded as the degree of priority. Alternatively, without using the handling difficulty level, the prediction value of the reference frequency may be regarded as the degree of priority. Further, which of the prediction value of the reference frequency and the handling difficulty level is to be reflected in the degree of priority may be set.

In any of the above methods, the higher the priority value, the higher the degree of priority.

Subsequently, an example of a dynamic calculation method will be described with respect of the evaluation period set in S301 and the unit period set in S302 of FIG. 9.

Generally, the unit period (width of the class) is fixed on a monthly basis and so forth. However, when the unit period is fixed on a monthly basis, time series changes in data may be difficult to capture when the number of data is not enough.

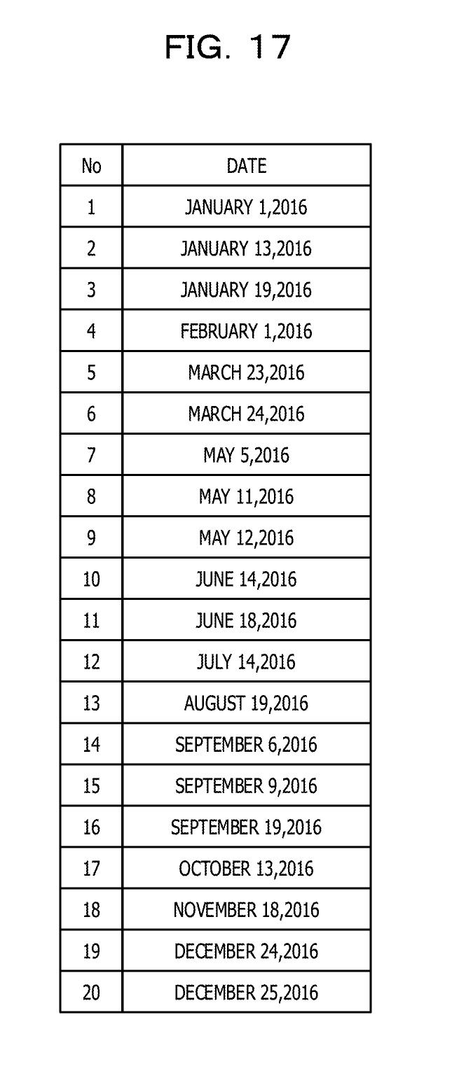

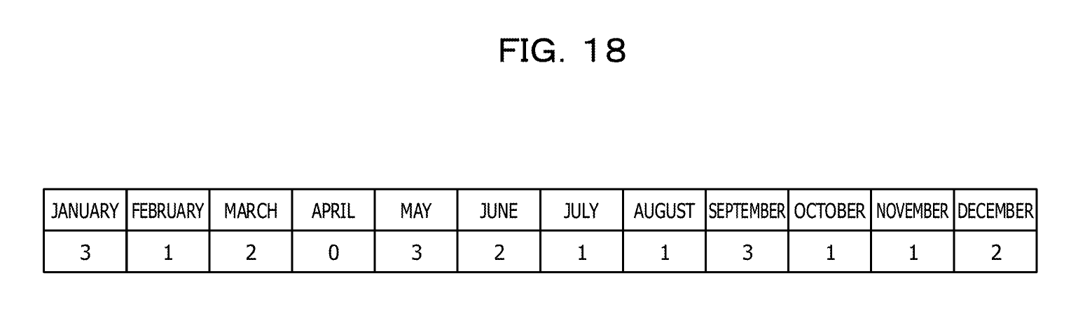

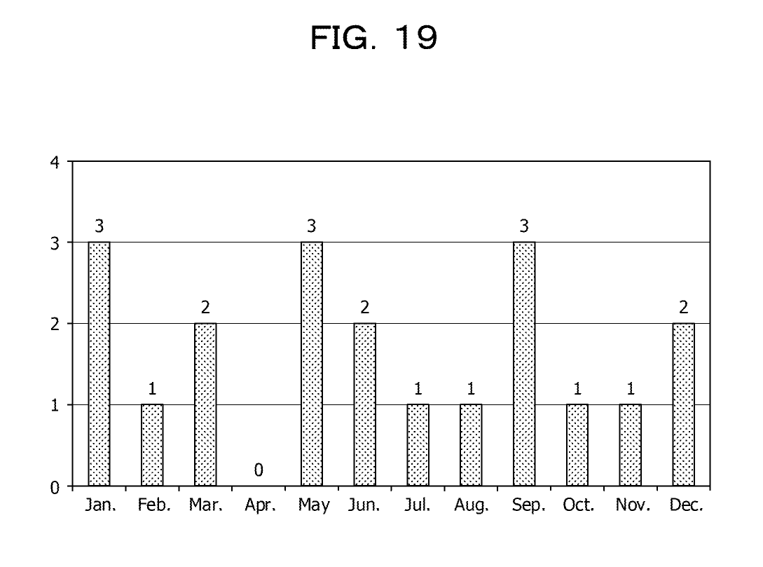

For example, suppose that there is a reference history with dates as illustrated in FIG. 17. In this case, the counting result of the reference frequency on a monthly basis is illustrated in FIG. 18. FIG. 19 is a diagram illustrating the counting result of the reference frequency on a monthly basis by a bar chart. It may be said that the variation in the counting on a monthly basis is large, and it is difficult to capture the tendency of time series change.

Therefore, in the present embodiment, the reference frequency prediction unit 128 may dynamically set the evaluation period and the unit period based on the reference history.

For example, the reference frequency prediction unit 128 sets the oldest reference date and time as the start date and time, and the current date and time or the latest reference date and time as the end date and time among a set of reference histories of respective target case information, and sets the period from the start date and time to the end date and time as the evaluation period.

The reference frequency prediction unit 128 sets the unit period using the following Sturges' formula.

k=log₂ (N+1)

Sturges' formula is a formula for obtaining a rough indication for determining the number of classes when creating a frequency distribution table or a histogram. N is the sample size, and k is the class number.

By applying the number of data of the reference histories in the evaluation period to N, the number of unit periods may be calculated as k.

Number of unit periods=log₂ (the number of data+1) (1)

The unit periods may be obtained by dividing the evaluation period by the number of the relevant unit periods.

Unit Period=Evaluation Period/Number of Unit Periods (2)

In the reference history of FIG. 17, the period from the start date and time to the end date and time is about 12 months. According to equation (1), it is found that the number of unit periods is preferably “5” to “6”. In this case, when “6” is used, the unit period is two months.

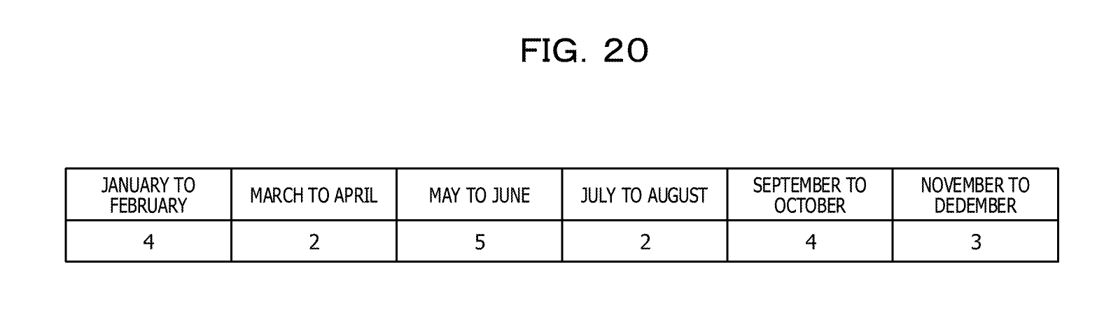

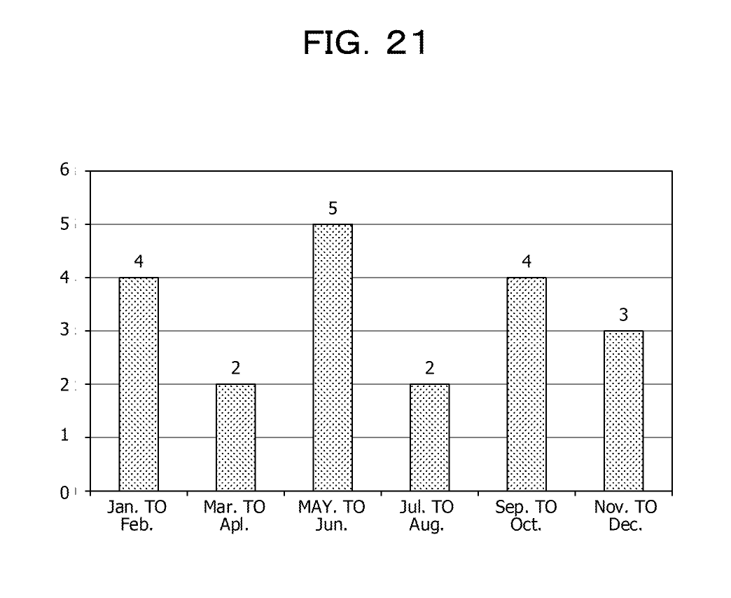

FIG. 20 illustrates the counting result of the reference frequency on a two-monthly basis. FIG. 21 illustrates the counting result of the reference frequency on a two-monthly basis by a bar chart.

By determining the unit period in this manner, it is possible to obtain the approximate straight line for the time series of the reference frequency based on the unit period according to the characteristics and so forth of the product A.

In the above example, the degree of priority of respective target case information is calculated based on the reference frequency. The degree of priority of respective target case information may be calculated based on the reference time in the reference history. For example, the reference frequency prediction unit 128 may calculate the total value or the average value of the reference time in the reference history corresponding to the target case information for respective target case information. Alternatively, the reference frequency prediction unit 128 may calculate the total value or the average value of the reference time for unit period for respective target case information, and as in the case of the reference frequency, an approximate straight line may be derived where the calculation result is represented by “y”, and the unit period is represented by “x”. Based on the derived approximate straight line, the prediction value of the total value or the average value of the reference time in the future unit period (next unit period) may be calculated. The priority calculation unit 130 may calculate the degree of priority of respective target case information so that the degree of priority is high as the total value or the average value of the past reference time, or the total value or the average value of the reference time in the next unit period is large.

As described above, according to the present embodiment, the degree of priority for output (display) is controlled based on the information (load information) indicating the load of work in respective cases with respect to respective case information corresponding to the inquiry (incident). Therefore, it is possible to preferentially present, to the user as the inquiring source, the case information that has a small degree of complication of work (for example, with high working efficiency) or whose the workload is small. As a result, it is possible to support the efficiency of work with respect to the inquiry.

The degree of priority is controlled in this manner, so that the possibility that the inquiry is solved by the user will increase. As a result, it is expected that the workload of respective support persons in the support environment Es may be reduced. Therefore, it is possible to support the efficiency of work with respect to the inquiry also from such a viewpoint.

In the present embodiment, the reference frequency, the reference time or the like of the case information corresponding to the inquiry is also used for the control of the degree of priority. The case information with a large reference frequency and the case information with a longer reference time may be case information that is highly likely to be useful to solve past inquiries. Therefore, use of the reference frequency or the reference time for controlling the degree of priority makes it possible to increase the possibility that case information which is effective for the user is provided.

In the present embodiment, an approximate straight line is calculated based on the past actual values with respect to the reference frequency and the reference time of the case information, and a future prediction value is calculated based on the calculated approximate straight line, whereby the future prediction value is also used for controlling the degree of priority. Therefore it is possible to increase the degree of priority of the case information in which the reference frequency or the reference time has a tendency to increase in consideration of the tendency of change in the time series of the reference frequency, the reference time, and so forth. As a result, it is possible to increase the possibility of providing case information which takes into consideration the occurrence tendency of the inquiry (incident) and the degree of influence on the user in handling the case, and thereby is effective for the user to solve the inquiry.

It is possible to impart an appropriate priority according to the tendency of the reference frequency and so forth even to new case information which has a small number of reference histories, but whose reference frequency is increasing by taking into consideration the prediction value of the reference frequency or the reference time.

In the present embodiment, the example where the case providing device 10 has the configuration illustrated in FIG. 3 has been described. Respective user terminals 30 may have the configuration illustrated in FIG. 3. Alternatively, the case providing device 10 may have the case DB 141 and the reference history DB 142, and respective user terminals 30 may have other components.

In this embodiment, the case providing device 10 is an example of a control device. The case information is an example of reference information. For example, this embodiment may be applied to information other than the case information and used for reference. The case registration unit 122 is an example of a reception unit. The priority calculation unit 130 is an example of a control unit.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
receiving an input of load information of work for handling an inquiry or an incident in association with each of a plurality of reference information, and
controlling a degree of priority of reference information to be output according to retrieval relating to the inquiry with respect to each of the plurality of reference information in accordance with the load information input relating to the reference information.

2. The storage medium according to claim 1,
wherein the load information is information indicating a measured time for the work or a degree of complication of the work.

3. The storage medium according to claim 2,
wherein information indicating the degree of complication of the work is the number of commands input to a console for the work.

4. The storage medium according to claim 1,
wherein the controlling includes controlling using a reference frequency or a reference time of each of the plurality of reference information.

5. The storage medium according to claim 1, wherein the process further comprising:
calculating a prediction value of a reference frequency or a reference time in unit period in a future with respect to each of the plurality of reference information, based on a history of the reference frequency or the reference time in unit period of each of the plurality of reference information,
wherein the controlling includes controlling using the calculated prediction value.

6. A control device comprising:
a memory; and
a processor coupled to the memory and configured to:
accept an input of load information of work for handling an inquiry or an incident in association with each of a plurality of reference information, and
control a degree of priority of reference information to be output according to retrieval relating to the inquiry with respect to each of the plurality of reference information in accordance with the load information input relating to the reference information.

7. The control device according to claim 6,
wherein the load information is information indicating a measured time for the work or a degree of complication of the work.

8. The control device according to claim 7,
wherein information indicating the degree of complication of the work is the number of commands input to a console for the work.

9. The control device according to claim 6,
wherein the processor is configured to control the degree of priority using a reference frequency or a reference time of each of the plurality of reference information.

10. The control device according to claim 6, wherein the processor is configured to:
calculate a prediction value of a reference frequency or a reference time in unit period in a future with respect to each of the plurality of reference information, based on a history of the reference frequency or the reference time in unit period of each of the plurality of reference information, and
control the degree of priority using the calculated prediction value.

11. A control method executed by a processor included in the control device, the control method comprising:
receiving an input of load information of work for handling an inquiry or an incident in association with each of a plurality of reference information, and
controlling a degree of priority of reference information to be output according to retrieval relating to the inquiry with respect to each of the plurality of pieces of reference information in accordance with the load information input relating to the reference information.
